(19) United States
(12) Patent Application Publication
(10) Pub. No.: US 2009/0034529 A1
(43) Pub. Date: Feb. 5, 2009

(54) METHOD AND APPARATUS FOR ROUTING PACKETS VIA HEADER-COMPRESSION CHANNELS

(75) Inventor: Jay J. Dawdy, Algonquin, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/132,767

(22) Filed: Jun. 4, 2008

Related U.S. Application Data
(60) Provisional application No. 60/952,639, filed on Jul. 30, 2007.

(51) Int. Cl. H04L 12/56

(52) U.S. Cl. 370/392; 370/467

(57) ABSTRACT

Various embodiments are described for routing packets via header-compression channels. A communication device sends (12, 13) signaling to another device to establish packet classifiers for a first header-compression channel and a second channel, which may or may not be a header-compression channel. Having received (22, 23) this signaling, the other device sends (24) packets to the communication device (14) via either the first header-compression channel or the second based on the packet classifiers and one or more of attributes of each packet.

### REFERENCE(S) TO RELATED APPLICATION(S)

The present application claims priority from a provisional application Ser. No. 60/952,639, entitled “METHOD AND APPARATUS FOR ROUTING PACKETS VIA HEADER-COMPRESSION CHANNELS,” filed Jul. 30, 2007, which is commonly owned and incorporated herein by reference in its entirety.

### FIELD OF THE INVENTION

The present invention relates generally to communication systems and, in particular, to routing packets via header-compression channels.

### BACKGROUND OF THE INVENTION

At present, there is a desire to make applications such as those in end-user devices (mobile stations (MSs), for example) more agonistic regarding the QoS (quality of service), policies, etc. of the particular underlying network on which they happen to be operating. Such applications, therefore, rely on this underlying network to effectively manage and utilize the available channel resources to provide the level of packet communications desired. Network interfaces such as IEEE 802.16 allow the instantiation of multiple MAC (media access control) layer channels per endpoint (e.g., per MS). At present, 802.16 currently supports several convergence sub-layer (CS) types that provide a mechanism for routing packets arriving at the MAC layer to the correct MAC channel.

The deficiency of this mechanism is that it does not work for header-compressed packets such as those compressed using Internet Engineering Task Force (IETF) RFC 3095 Robust Header Compression (ROHC) or other protocols that compress or otherwise hide packet headers prior their arrival at the 802.16 CS. Thus, when multiple ROHC channels are involved there is no way for the present mechanism to determine which ROHC channel to use or whether any ROHC channel should be used at all. Therefore, new techniques for routing packets via header-compression channels are clearly desirable for advancing the art in this area.

### BRIEF DESCRIPTION OF THE DRAWINGS

FIG. 1 is a logic flow diagram of functionality performed by a communication device in accordance with multiple embodiments of the present invention.

FIG. 2 is a logic flow diagram of functionality performed by a communication device in accordance with multiple embodiments of the present invention.

FIG. 3 is a block diagram depiction of a wireless communication system in accordance with multiple embodiments of the present invention.

FIG. 4 is a signaling flow diagram that depicts the routing of ROHC packets via 802.16-ROHC channels, in accordance with certain embodiments of the present invention.

FIG. 5 is a signaling flow diagram that depicts the routing of packets via 802.16 channels, in accordance with the prior art.

FIG. 6 is a signaling flow diagram that depicts the configuring of multiple 802.16-ROHC channels, in accordance with the prior art.

FIG. 7 is a signaling flow diagram that depicts the routing of packets via an 802.16 channel and an 802.16-ROHC channel, in accordance with certain embodiments of the present invention.

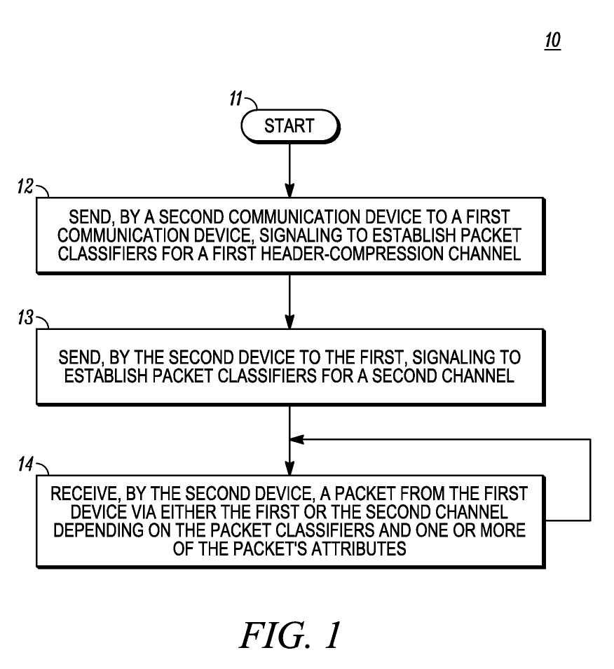

Specific embodiments of the present invention are disclosed below with reference to FIGS. 1-4 and 7. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

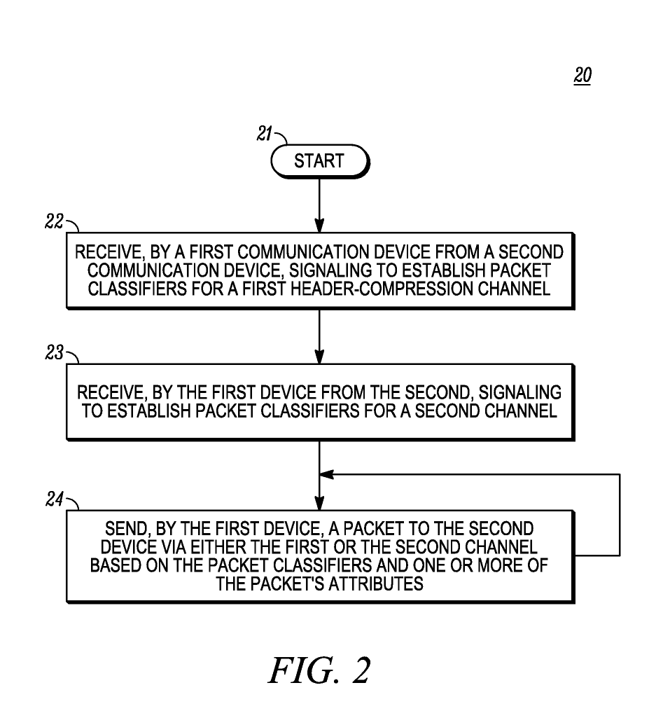

Various embodiments are described for routing packets via header-compression channels. Logic flow diagrams 10 and 20, in FIGS. 1 and 2, depict functionality performed in accordance with multiple embodiments of the present invention. A communication device sends (12, 13) signaling to another device to establish packet classifiers for a first header-compression and a second channel, which may or may not be a header-compression channel. Having received (22, 23) this signaling, the other device sends (24) packets to the communication device (14) via either the first channel or the second based on the packet classifiers and one or more of attributes of each packet.

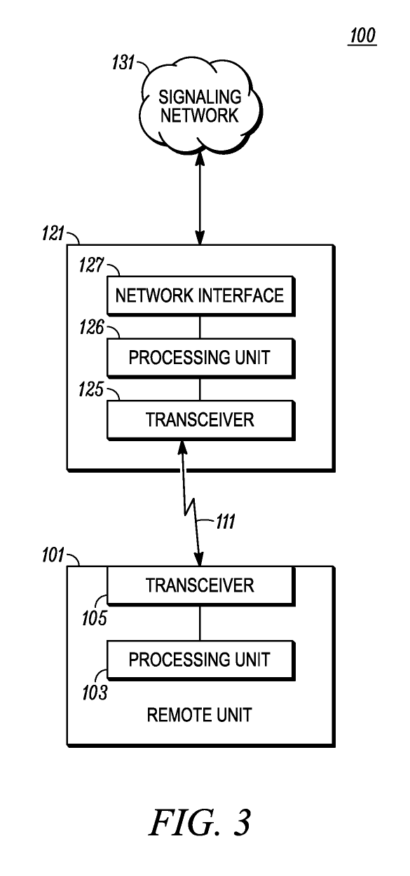

The disclosed embodiments can be more fully understood with reference now to FIGS. 3, 4 and 7. FIG. 3 is a block diagram depiction of a wireless communication system 100 in accordance with multiple embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/ respectively.) Communication system 100 represents a system having an architecture in accordance with one or more of the WiMAX Forum and/or IEEE 802 technologies, suitably modified to implement the present invention. Alternative embodiments of the present invention may be implemented in communication systems that employ other or additional technologies such as, but not limited to, those described in the OMA, 3GPP, and/or 3GPP2 specifications.

Communication system 100 is depicted in a very generalized manner. For example, system 100 is shown to simply include remote unit 101, network node 121 and signaling network 131. Network node 121 is shown having interconnectivity via signaling network 131. Network node 121 is shown providing network service to remote unit 101 using wireless interface 111. The wireless interface used is in accordance with the particular access technology supported by network node 121, such as one based on IEEE 802.16. Those skilled in the art will recognize that FIG. 3 does not depict all of the physical fixed network components that may be necessary for system 100 to operate but only those system components and logical entities particularly relevant to the description of embodiments herein.

As depicted in FIG. 3, network node 121 comprises a processing unit 126, a network interface 127 and a transceiver 125. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, device 121 represents a known device that has been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more RAN components, such as a base transceiver station (BTS) and/or a base station controller (BSC), a Node-B and/or a radio network controller (RNC), or an HRPD AN and/or PCF, or implemented in or across one or more access network (AN) components, such as an access service network (ASN) gateway and/or ASN base station (BS), an access point (AP), a wideband base station (WBS), and/or a WLAN (wireless local area network) station.

Remote unit 101 and network node 121 are shown communicating via technology-dependent, wireless interface 111. Remote units, subscriber stations (SSs) and/or user equipment (UEs), may be thought of as mobile stations (MSs), mobile subscriber stations (MSSs), mobile devices or mobile nodes (MNs). In addition, remote unit platforms are known to refer to a wide variety of consumer electronic platforms such as, but not limited to, mobile stations (MSs), access terminals (ATs), terminal equipment, mobile devices, gaming devices, personal computers, and personal digital assistants (PDAs). In particular, remote unit 101 comprises a processing unit (103) and transceiver (105). Depending on the embodiment, remote unit 101 may additionally comprise a keypad (not shown), a speaker (not shown), a microphone (not shown), and a display (not shown). Processing units, transceivers, keypads, speakers, microphones, and displays as used in remote units are all well-known in the art.

Operation of embodiments in accordance with the present invention occurs substantially as follows, first with reference to FIG. 3. As depicted in FIG. 3, network node 121 is the current serving node for remote unit 101. For the sake of example, it will be assumed that wireless interface 111 comprises two header-compression channels. Each of these channels is used for transferring packets to which at least some type of header compression has been applied. Examples of various header compression techniques that may be associated with either channel include Robust Header Compression (ROHC), IP/UDP/RTP header compression (based on RFC 2508, Compressing IP/UDP/RTP Headers for Low-Speed Serial Links), IP header compression (based on RFC 2507, IP Header compression), and TCP/IP header compression (based on RFC 1144, Compressing TCP/IP Headers for Low-Speed Serial Links).

Processing unit 126 of network node 121 sends via transceiver 125 signaling to establish packet classifiers for both header-compression channels. Processing unit 103 receives the signaling to establish the packet classifiers via transceiver 105 and installs the appropriate classifiers, for each header-compression channel, accordingly, to be used in routing packets via the channels. In general, the signaling to establish the packet classifiers for each channel includes an indication to the other device of what types of packets can and/or should be sent via that channel.

In some embodiments, the signaling to establish the packet classifiers may also indicate to the other device what types of packets can and/or should be given priority and may also indicate how the channels should be given priority. For example, what types of packets should be sent first via a channel should multiple packets be ready to send or which channel has priority in selection should a packet meet the classification criteria of both. Thus, depending on the embodiment, the signaling to establish the packet classifiers for a header-compression channel may include either or both an indication of what packet types may be sent via the channel and a classifier rule to be used for the channel.

As packets are sent by applications, such as those perhaps also running on processing unit 103, those running on remote unit 101 but not on processing unit 103 or those running on some device (not shown) communicatively coupled to remote unit 101, processing unit 103 uses the packet classifiers established for the header-compression channels to route the packets to the proper channel for transfer to processing unit 126 via transceivers 105 and 125. Although in this example, processing unit 126 of network node 121 sent the signaling to establish packet classifiers to be used by processing unit 103 in routing packets, processing unit 103 could have instead (or additionally) sent signaling to establish packet classifiers to be used by processing unit 126 for routing packets in the opposite direction.

In addition, for the sake of example, it was assumed above that wireless interface 111 comprised two header-compression channels. However, in some embodiments, only one of the channels may be a header-compression channel. In either case, signaling is sent to establish packet classifiers for each of channels, whether header-compressed or not.

Reference has been made to IEEE 802.16 embodiments above. Therefore, a summary that focuses on certain IEEE 802.16 embodiments appears below to provide some additional, and more particular examples. They are intended to further the reader's understanding of the variety of possible embodiments rather than to limit the scope of the invention.

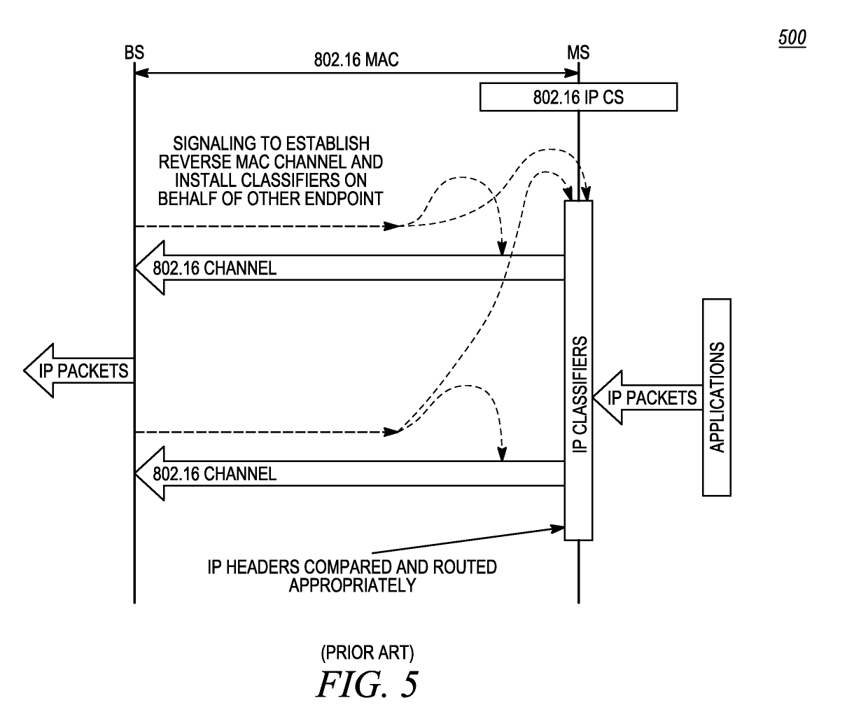

First, in the 802.16 space, some packet routing techniques are presently used. FIG. 5 is a signaling flow diagram 500 that depicts the routing of packets via 802.16 channels, in accordance with the prior art. For example, a BS may send signaling to an MS to establish reverse MAC layer channels and to install classifiers to be used by the MAC layer in the MS for appropriately routing IP packets among the established 802.16 channels. The MAC layer in the MS uses the installed classifiers and the IP headers in each packet to determine the proper 802.16 channel to use for that packet.

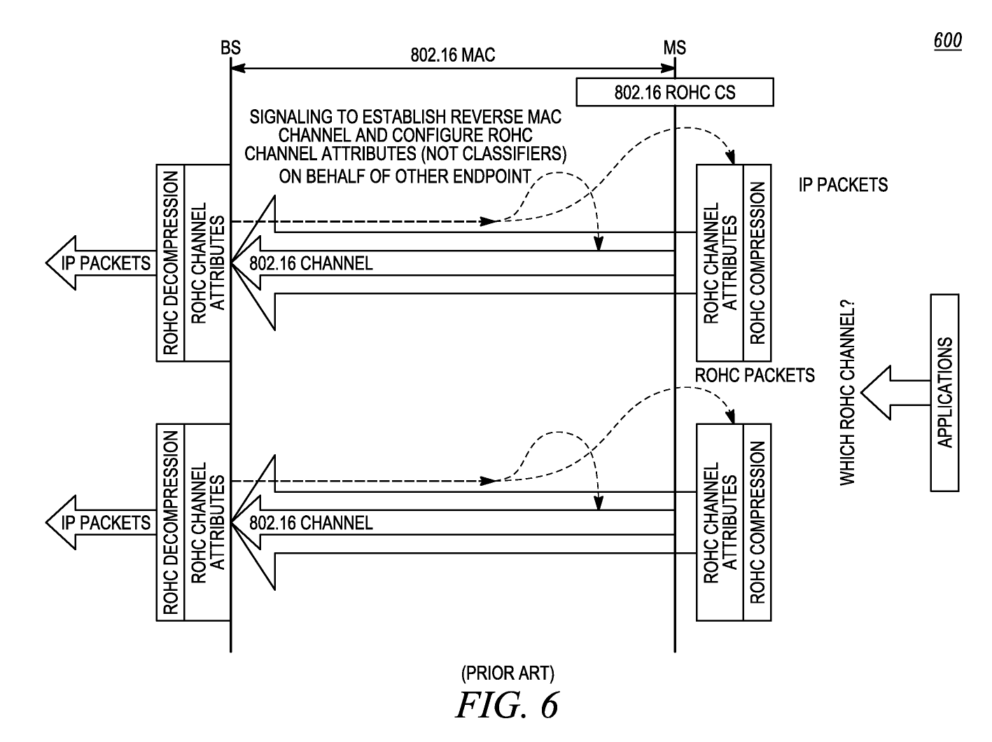

FIG. 6 is a signaling flow diagram 600 that depicts the configuring of multiple 802.16-ROHC channels, in accordance with the prior art. For example, a BS may send signaling to an MS to establish reverse MAC layer channels and to configure them as ROHC channels having attributes supplied by the BS. However, the introduction of header-compression channels creates issues for routing packets.

802.16e-2005, prior to modification in 802.16e-2004_Cor_D1, proposed the use of ROHC context ID (ROHC CID) to route packets to the correct 802.16 connection (service flow). In this implementation, however, only one ROHC channel per user could be used. This limitation was deemed to be too inflexible. The use of ROHC CID as means of routing was therefore discarded and the association of one ROHC channel per 802.16 service flow ID (SFID) was mandated in 802.16e-2004_Cor_D1 along with a “ROHC Payload” container that can be used to indicate parameters to the ROHC peer. Currently, the only existing proposal of the contents of the “ROHC payload” is described in “061222_NWG_ROHC_Parameter_Format.doc” in the WiMAX NWG working group forum. This proposal only indicates the usual ROHC channel parameters such as MAX_CID, FEEDBACK_FOR, and PROFILES. However, none of these parameters are useful in indicating to the end user device which packets should flow over the ROHC channel.

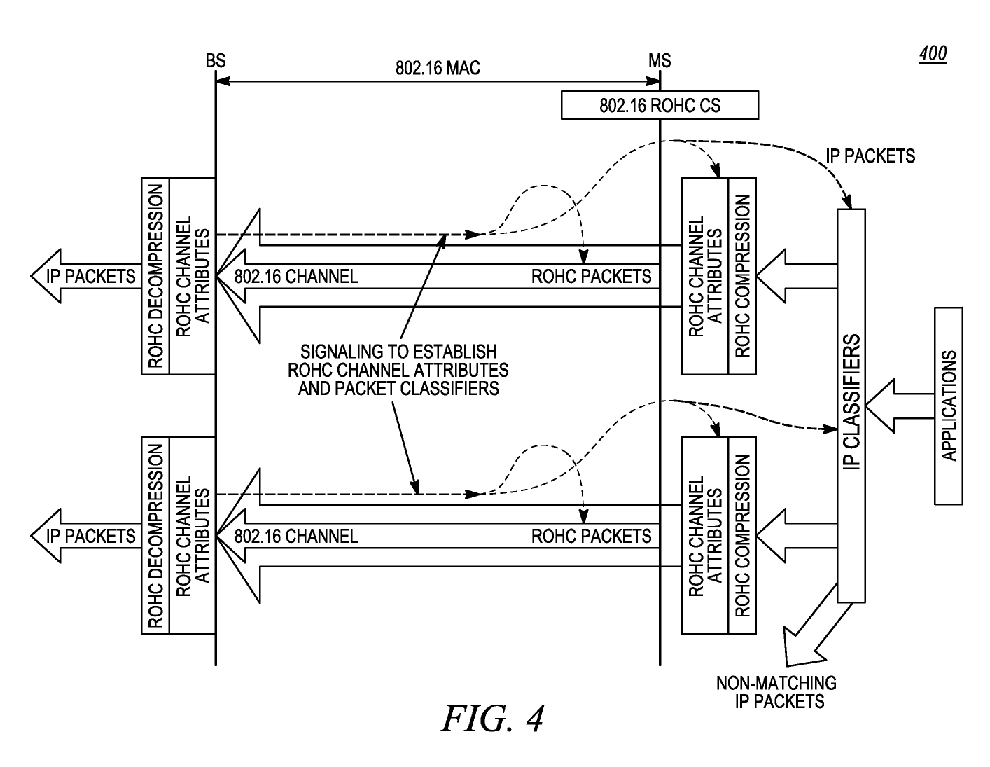

FIG. 4 is a signaling flow diagram 400 that depicts the routing of ROHC packets via 802.16-ROHC channels, in accordance with certain embodiments of the present invention. As depicted, a BS may send signaling to an MS to establish packet classifiers in addition to ROHC channel attributes. Thus, classification rules may be passed from a controlling upper layer endpoint (such as an endpoint above the MAC layer in the BS) to a recipient upper layer endpoint (such as an endpoint between the MAC layer and applications in the MS) via 802.16 that will enable the routing of ROHC packets to an intended ROHC-802.16 channel. (Endpoints, i.e. protocol endpoints, may take various forms such as that of an application programming interface.) The recipient upper layer endpoint can then route ROHC packets on behalf of the controlling endpoint as indicated by the packet classifiers. By passing the packet classifiers in this manner, the routing and enforcement rules are effectively hidden from the lower layer (i.e., the MAC layer).

Contribution “061222_NWG_ROHC_Parameter_Format.doc” (referred to above) sufficiently describes the TLVs (Type, Length and Values) required for negotiating ROHC channel parameters over an 802.16e service flow; however, a mechanism that conveys classification information for the purpose of routing packets to a specific ROHC channel is not defined in the document. Definition of such a mechanism is particularly desirable in cases where multiple service flows are established and the BS is creating uplink ROHC channel service flows on behalf of the MS or the MS is creating downlink ROHC channel service flows on behalf of the BS.

In certain embodiments of the present invention, additional TLVs of the same format as described in “061222_NWG_ROHC_Parameter_Format.doc” are added to the “ROHC Parameter Payload.” These additional TLVs add the ability for ROHC peers to pass information about packet types and classification rules for the purpose of routing packets to a ROHC channel based on an 802.16e-based MAC.

There are no requirements regarding what network elements or protocol layers in the network perform the classification. Presumably, however, classification would be done prior to ROHC compression in order to have the ability to filter packet headers.

The following table shows in detail an example of what additions may be made to the “ROHC Parameter Payload”:

| Assigned | | | | |
|---|---|---|---|---|
| Number for | | ROHC- | | |
| ROHC- | ROHC-Parameter- | Parameter- | Description for ROHC- | |
| Parameter-Type | Type Name | Length | Parameter-Value | M/O |
| 6 | PACKET_TYPES | 1 | These are the packet types | O |
| | | | allowed to enter this ROHC | |
| | | | Channel. 0b1 = enabled. | |
| | | | 0b0 = disabled | |
| | | | Bit 0 = IPV4 | |
| | | | Bit 1 = IPV6 | |
| | | | Bit 2-7 = Reserved | |
| 7 | CLASSIFIERS | 1-256 | One Classifier rule of the | O |
| | | | type(s) specified in | |
| | | | PACKET_TYPES. The | |
| | | | format will be consistent | |
| | | | with that of IEEE 802.16 as | |
| | | | follows: | |
| | | | For PACKET_TYPES | |
| | | | IPV4 and IPV6 the | |
| | | | parameter types supported | |
| | | | in 802.16 TLV format are²: | |
| | | | Type [108].1-DSC | |
| | | | Action | |
| | | | Type [108].3-Packet | |
| | | | Classification Rule | |
| | | | Type [108].3.1 | |
| | | | Classifier Rule | |
| | | | Priority | |
| | | | Type [108].3.2 IP | |
| | | | Type of | |
| | | | service/differentiated | |
| | | | services code | |
| | | | point (DSCP) range | |
| | | | and mask | |
| | | | Type [108].3.3- | |
| | | | Protocol | |
| | | | Type [108].3.4 - IP | |
| | | | masked source | |
| | | | address | |
| | | | Type [108].3.5 - IP | |
| | | | destination address | |
| | | | Type [108].3.6 - | |
| | | | Protocol source port | |
| | | | range | |
| | | | Type [108].3.7 - | |
| | | | Protocol destination | |
| | | | port range | |
| | | | Type[108].3.14 - | |
| | | | Packet | |
| | | | Classification Rule | |
| | | | Index | |
| | | | For packet type | |
| | | | IPV6 [108].3.15 - | |
| | | | IPV6 flow label | |

0, 8~255 for ROHC-Parameter-Type are reserved.
²“cst” value of 108 for “Packet, IP with header ROHC compression” is used to avoid creating any implied dependencies between the ROHC and IP convergence sublayers

One benefit of adding to the “ROHC Parameter Payload” container is that it allows the “ROHC Payload” to be technology portable and agnostic of its underlying delivery mechanism. In addition and more generally, allowing the fixed network to indicate or dictate to the end device the way to identify what packet types are allowed to flow over an 802.16e connection, a fixed network can successfully implement a “push” model where the end device need not determine on its own how to use or map packets to underlying resources.

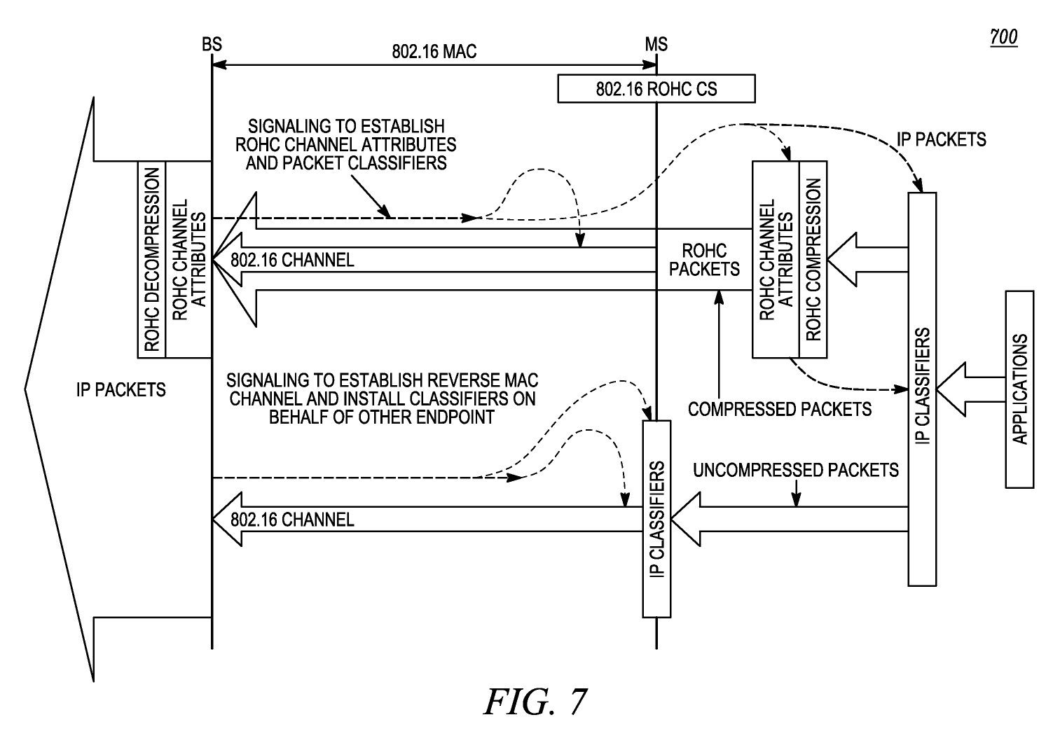

FIG. 7 is a signaling flow diagram 700 that depicts the routing of packets via an 802.16 channel and an 802.16-ROHC channel, in accordance with certain embodiments of the present invention. Diagram 700 is provided to illustrate that not all of the channels among which packets may need to be routed may be header-compression channels and also that packets may need to be routed among channels where as few as one is a header-compression channel.

One of skill in the art will appreciate that various modifications and changes may be made to the specific embodiments described above with respect to FIGS. 4 and 7 without departing from the spirit and scope of the present invention. Thus, the discussion of certain embodiments in greater detail above is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, and the conveyance of some symbol representing the information or object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for routing packets via header-compression channels comprising:
receiving, by a first communication device from a second communication device, signaling to establish packet classifiers for a first header-compression channel;
receiving, by the first communication device from the second communication device, signaling to establish packet classifiers for a second channel;
sending, by the first communication device, a packet to the second communication device via one of the first header-compression channel and the second channel based on at least one attribute of the packet and on the packet classifiers established for the first and second channels.

2. The method of claim 1, wherein the signaling to establish packet classifiers for the first header-compression channel comprises an indication of at least one of
what packet types may be sent via the first header-compression channel and
at least one classifier rule to be used for the first header-compression channel.

3. The method of claim 1, wherein the second channel comprises a header-compression channel and wherein the signaling to establish packet classifiers for the second channel comprises an indication of at least one of
what packet types may be sent via the second channel and
at least one classifier rule to be used for the second channel.

4. The method of claim 1, wherein the first and second channels are each associated with a different wireless physical channel.

5. The method of claim 4, wherein the second channel comprises a header-compression channel and wherein the first and second header-compression channels are each associated with a different IEEE 802.16 service flow identifier (SFID).

6. The method of claim 1, wherein the first and second channels are both MAC (media access control) layer channels.

7. The method of claim 1, wherein the first header-compression channel comprises at least one of:
a channel for which Robust Header Compression (ROHC) is applied to packets,
a channel for which IP/UDP/RTP header compression is applied to packets,
a channel for which IP header compression is applied to packets, and
a channel for which TCP/IP header compression is applied to packets.

8. The method of claim 1, wherein the second channel comprises a header-compression channel which comprises at least one of:
a channel for which Robust Header Compression (ROHC) is applied to packets,
a channel for which IP/UDP/RTP header compression is applied to packets,
a channel for which IP header compression is applied to packets, and
a channel for which TCP/IP header compression is applied to packets.

9. The method of claim 1,
wherein receiving by the first communication device signaling to establish packet classifiers for the first header-compression channel comprises
receiving, by a recipient protocol endpoint situated between the MAC (media access control) layer and an application in the first communication device, signaling to establish packet classifiers for the first header-compression channel and
wherein the second channel comprises a header-compression channel and wherein receiving by the first communication device signaling to establish packet classifiers for the second channel comprises
receiving, by the recipient protocol endpoint in the first communication device, signaling to establish packet classifiers for the second channel.

10. The method of claim 9, wherein sending the packet by the first communication device comprises
selecting, by the recipient protocol endpoint, one of the first and second header-compression channels based on at least one attribute of the packet and on the packet classifiers established for the first and second header-compression channels; and
sending the packet by the recipient protocol endpoint via the selected header-compression channel.

11. A method for routing packets via header-compression channels comprising:
sending, by a second communication device to a first communication device, signaling to establish packet classifiers for a first header-compression channel;
sending, by the second communication device to the first communication device, signaling to establish packet classifiers for a second channel;
receiving, by the second communication device, a packet from the first communication device via one of the first header-compression channel and the second channel in accordance with at least one attribute of the packet and in accordance with the signaling to establish packet classifiers for each channel.

12. The method of claim 11,
wherein sending by the second communication device signaling to establish packet classifiers for the first header-compression channel comprises
sending, by a controlling protocol endpoint situated between the MAC (media access control) layer and an application in the second communication device, signaling to establish packet classifiers for the first header-compression channel and
wherein the second channel comprises a header-compression channel and wherein sending by the second communication device signaling to establish packet classifiers for the second channel comprises
sending, by the controlling protocol endpoint in the second communication device, signaling to establish packet classifiers for the second channel.

13. The method of claim 12, wherein receiving the packet by the second communication device comprises
receiving the packet by the controlling protocol endpoint.

14. A communication device for routing packets via header-compression channels comprising:
a transceiver;
a processing unit, communicatively coupled to the transceiver,
adapted to receive, from a second communication device via the transceiver, signaling to establish packet classifiers for a first header-compression channel,
adapted to receive, from the second communication device via the transceiver, signaling to establish packet classifiers for a second channel, and
adapted to send, via the transceiver, a packet to the second communication device via one of the first header-compression channel and the second channel based on at least one attribute of the packet and on the packet classifiers established for the first and second channels.

15. The communication device of claim 14, wherein the communication device comprises one of a remote unit and a network node.

16. A communication device for routing packets via header-compression channels comprising:
a transceiver;
a processing unit, communicatively coupled to the transceiver,
adapted to send, to another communication device via the transceiver, signaling to establish packet classifiers for a first header-compression channel,
adapted to send, to the other communication device via the transceiver, signaling to establish packet classifiers for a second channel, and
adapted to receive, via the transceiver, a packet from the other communication device via one of the first header-compression channel and the second channel in accordance with at least one attribute of the packet and in accordance with the signaling to establish packet classifiers for each channel.

17. The communication device of claim 16, wherein the communication device comprises one of a remote unit and a network node.
